(19) United States
(12) Patent Application Publication
(10) Pub. No.: US 2022/0203709 A1
(43) Pub. Date: Jun. 30, 2022

(54) APPARATUS AND METHOD FOR PREPARING A CYLINDRICAL OBJECT FOR DECORATING THEREON

(71) Applicant: TONEJET LIMITED, Melbourn, Royston (GB)

(72) Inventors: Ian Philip Butler Ingham, Cambridge, Cambridgeshire (GB); Jonathan James Michael Halls, Cambridge, Cambridgeshire (GB); Shaun Christopher Hazlewood, Cambridge, Cambridgeshire (GB); Jeffrey Mark Woods, Cambridge, Cambridgeshire (GB)

(21) Appl. No.: 17/606,171

(22) PCT Filed: Apr. 26, 2019
(86) PCT No.: PCT/GB2019/051172

§ 371 Date: Oct. 25, 2021

(51) Int. Cl. B41J 3/407; B41J 2/165; B41F 17/00; B41F 17/22

(52) U.S. Cl. CPC B41J 3/40733; B41J 2/16552; B41J 2002/16558; B41F 17/22; B41J 2002/16555; B41F 17/002

(57) ABSTRACT

An apparatus (200) and method for preparing a cylindrical object having a protective surface coating, such as a necked can (100), for decorating thereon using a printing technique. According to the method, a primer is applied onto the surface coating, and the primer is then dried to form a surface for decorating the object. The apparatus comprises a priming station (260) for applying a primer onto said surface coating, and a drying station (270) for drying the primer.

### INTRODUCTION

This invention relates to techniques for decorating cylindrical objects or containers. More specifically, the present invention provides an apparatus and method for preparing a cylindrical object, such as a can, having a protective surface coating for decorating thereon using a printing technique, such as an inkjet printing technique.

### BACKGROUND TO THE INVENTION

Cylindrical objects or containers are often provided with a protective surface coating for pre-processing or forming them and/or to provide protection to the cylindrical object during packing and transportation. A particular example of a cylindrical object of interest is cans such as those used to contain beverages. Such cans usually comprise a cylindrical main body having a base and side walls formed from a single piece of material, usually aluminium, less usually steel, in a number of forming steps. Once initially formed, such cans may be subsequently “necked” to reduce the diameter of the open end before filling the can with the intended contents. After filling, a circular lid is crimped to the, optionally necked, open end of the can body to provide a closed container. Cans of this type are commonly called two-piece cans.

While the present disclosure will refer to necked cans in particular, it will of course be appreciated that the aspects disclosed herein may equally be applied to a can that has not been necked.

In order to neck a cylindrical can body, it is typically subjected to a series of die-forming steps in a necking machine, each step reducing the diameter of the open end of the can by about 1 mm. This is achieved by pushing the can body axially into a tapered die, which applies a radially compressive force to the open end of the main body of the can to urge it inwards as the can is forced into the die. Over a series of such steps, involving a succession of dies of reducing diameter, the neck is formed to the required diameter. In a final operation, a flange is formed on the open neck of the can by the action of a flanging tool comprising profiled rollers that rotate around the neck to form the flange.

Most two-piece cans are formed from a metallic material, such as aluminium, which is advantageously lightweight and malleable. However, the surface of aluminium tends to bind and abrade easily when rubbed against other surfaces. Lubrication is therefore required during the necking process, and is normally provided by two means: firstly, cans are coated with a tough over-print varnish (OPV) to provide a “protective surface coating” that protects the can surface, wherein the OPV contains waxes to provide lubricity in the necking process and protection during subsequent transportation; secondly, an oil is used as a lubricant in the necking process.

Machinery for necking cans is substantial and is therefore usually located as part of a production line in a can manufacturing plant. Traditionally, decoration is applied to the outer surface of the main body of a can before the necking process, with an intermediate step of applying and curing an OPV after decoration and before necking, to provide the aforementioned lubricity and protection of the decorated can surface. Hence, decoration is traditionally also constrained to take place in the can manufacturing plant. This makes it difficult and uneconomic to produce small quantities of a chosen can design as is increasingly desired by large beverage brand owners, who wish to offer increasing levels of personalisation and customisation in their packaging for the consumer. Furthermore, the global trend for craft beverages from small producers, making relatively small batches of beverages, is driving demand for economic short-run decoration of cans, which offer advantages over bottles in terms of product protection and longevity, transportability and recyclability.

Hence, there are commercial opportunities for decorating cans later in the beverage packaging ecosystem, at or close to the stage of filling at the beverage manufacturer. Such opportunities exist for the decoration of cans both before and after filling with product and lidding.

This presents challenges: the surface of a necked can is not amenable to receiving print because of the lubricity and low surface energy of the OPV, and residues of necking oil will not accept print and furthermore tend to collect dirt and debris in transportation that can subsequently disrupt the printing process.

For these reasons, in most known examples of late-stage customisation, graphics are typically applied to the outer surface of the main body of the can via adhesive labels, paper or film, in which case the outer surface of the necked can, as received, is an adequate surface for application of the graphics in said form. But this comes at a greatly increased cost compared to direct printing of the can.

Hence it is desirable to print ink directly onto the cans. Certain systems exist for this purpose, such as that taught by WO 2018/083164. However, it has been found that the quality and reliability of printing is greatly improved if the outer surface of the necked can and, in particular, the main body, is suitably prepared prior to decorating thereon.

### SUMMARY OF INVENTION

Described herein is an apparatus for preparing a cylindrical object having a protective surface coating for decorating thereon using a printing technique, the apparatus comprising: a priming station for applying a primer onto said surface coating; and a drying station for drying said primer; wherein the primer forms a surface for decorating the object.

The priming station may comprise a transfer roller. The priming station may further comprise an offset gravure arrangement including a gravure cylinder and a transfer roller. The transfer roller may be operable selectively to be brought into contact with the surface of the object, while maintaining contact with the gravure cylinder. The priming station may further comprise a drive mechanism arranged to engage with the object so as to drive axial rotation of the object while it is in contact with the transfer roller. The drive mechanism may be arranged to rotate the object at a speed independent of the speed of the transfer roller.

Preferably, the drying station is arranged to dry the primer by application of heat. The drying station may comprise at least one air blade arranged to direct heated air onto the surface formed by the primer. The drying station may further comprise a plurality of air blades arranged to direct heated air onto said surfaces of a plurality of said objects simultaneously. The drying station may further comprise a drive mechanism arranged to engage with the object so as to drive axial rotation of the object while it is being dried by heated air from the air blade(s).

The apparatus may further comprise a cleaning station for removing contaminants from the protective surface of the object.

Preferably, the cleaning station comprises a cleaning material against which the retained object may be moved (preferably, rotated) to clean the surface. The cleaning material may be provided on a substantially planar substrate. The substrate may comprise a compressible material, for example wherein said material is compressible relative to the object (such that the material compresses rather than the object when they are in contact). The substrate may comprise a closed-cell foam, preferably having a density of between 40 kg/m³ and 100 kg/m³, more preferably between 60 kg/m³ and 80 kg/m³.

The cleaning station may further comprise means for wetting the cleaning material with cleaning fluid. Preferably, only a portion of the cleaning material is wetted such that the object can be brought into contact with a wetted portion of the cleaning material before being brought into contact with a portion of the cleaning material that has not been wetted.

The cleaning station may further comprise a drive mechanism arranged to engage with the object so as to drive axial rotation of the object while positioned at the cleaning station, preferably wherein the object is axially rotated in a direction opposite to its direction of travel.

The apparatus may further comprise at least one (e.g. object) holding device arranged to position said object at each station. The holding device may be arranged to move an object, sequentially, between stations of the apparatus. Movement of the object between stations may be automated. As used herein, the term “automated” preferably connotes a process or procedure that is performed with minimal human assistance.

Preferably, the holding device is arranged to retain the cylindrical object by engaging with opposed ends of said object, said holding device further being arranged to allow said object to be rotated about its longitudinal axis while retained. The holding device may be further arranged to allow air to be supplied to a hollow interior of an object retained by the holding device whereby to pressurise said object.

The apparatus may further comprise at least one actuator arranged to actuate the holding device to release or retain an object when said object is in a predetermined position. The apparatus may (further) comprise a plurality of said holding devices.

The apparatus may further comprise a track (system) along which said at least one holding device is arranged to travel so as to move the retained object between stations. Preferably, at least one carriage is arranged to travel along the track (e.g. between stations in the apparatus) via a drive belt arrangement, wherein at least one holding device is mounted to said at least one carriage. Optionally, two or more holding devices may be mounted to a single carriage, and there may be multiple carriages disposed around the track. The carriages may be controlled to move a predetermined distance, d, along the track during a first time period, then remain stationary for a second time period. The sum of the first and the second time periods may equal a period of one second or less.

Such timing control may be useful to configure the apparatus to prepare each object in a period of time that corresponds to a period of time required to decorate an object using a suitable printing technique, for example when objects prepared by the apparatus are supplied immediately to be decorated as part of a production run.

Also described herein is a method of preparing a cylindrical object having a protective surface coating for decorating thereon using a printing technique, the method comprising: applying a primer onto the surface coating; and drying the primer; wherein the primer forms a surface for decorating the object.

Applying the primer onto the coating may be performed by a transfer roller. Applying the primer onto the coating may further be performed by an offset gravure process involving a gravure cylinder and a transfer roller. Preferably, applying the primer may comprise selectively bringing the transfer roller into contact with the surface of the object as it is rotated. Preferably, the object is rotated at a speed independent of the speed of the transfer roller when applying the primer, for example wherein the object may be rotated at twice the circumferential speed of the transfer roller.

The method may further comprise pressurising the interior of the object while applying the primer, and optionally prior to applying the primer.

The method may further comprise drying the primer by passing heated air over the surface of the object, preferably wherein the air has a temperature of at least 30° C.

The method may further comprise cleaning the coating to remove surface contaminants prior to applying the primer, preferably using a cleaning fluid. Preferably, cleaning the coating comprises wiping the object against a cleaning material. At least a portion of the cleaning material may be wetted with a cleaning fluid. Preferably, the object is wiped against a first portion of cleaning material that has been wetted with a cleaning fluid, and then wiped against a second portion of cleaning material that has not been wetted with a cleaning fluid. Preferably, the first and second portions are different portions of a single piece of cleaning material (e.g.

a fabric, preferably a non-woven and/or lint-free fabric).

Cleaning the coating may comprise rotating the object against the cleaning material so as to wipe the object, and preferably rotating the object in a direction opposite to the direction of travel of the object (e.g. the direction of travel of the object between stations in the apparatus described above). Preferably, the object is maintained in a laterally stationary position relative to the cleaning material while in contact with the cleaning material. The cleaning material may be arranged to contact the object over an arcuate portion of its circumference, preferably up to 20% of its circumference.

The cleaning fluid may be a solvent or a detergent solution. Preferably, the cleaning fluid comprises isopropyl alcohol or an aliphatic hydrocarbon.

The method may further comprise drying the surface of the coating after the object has contacted the cleaning fluid, prior to applying the primer.

Preferably, the method is automated.

Also described herein is a method of decorating a cylindrical object having a protective surface coating thereon, the method comprising: preparing the object for decorating using the method described above; and decorating the object using a printing technique.

Also described herein is a primer composition comprising an amphiphilic copolymer comprising Formula (I)

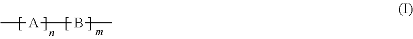

wherein A is a non-polar group;
B is a polar group; and
n and m are integers independently selected from 2 to 1,000,000.

A may be defined by Formula (A-I)

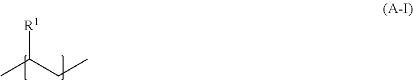

wherein R¹ is selected from the group consisting of
i. Hydrogen
ii. C₁ to C₄₀ alkyl, preferably C₁₂ to C₂₅ alkyl;
iii. C₂ to C₄₀ alkenyl, preferably C₁₂ to C₂₅ alkenyl;
iv. C₂ to C₄₀ alkynyl, preferably C₁₂ to C₂₅ alkynyl,
v. C₆ to C₄₀ aryl;
   wherein the alkyl, alkenyl, alkynyl and aryl are optionally substituted with halo;
   most preferably R¹ is C₁₂ to C₂₅ alkyl.

B may be defined by Formula (B-I)

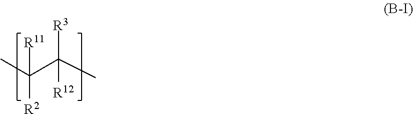

wherein R² and R³ are independently selected from the group consisting of H, halo, —R⁷—OR⁸, —R⁷═O, —R⁷—CO₂R⁸, —R⁷—NR⁸R⁸, —R⁷—NC(O)R⁸, —R⁷—C(O)NR⁸R⁸, wherein at least one of R² and R³ is not H, or
R² and R³ are taken together with the carbon to which they are attached to form a 4 to 7-membered cyclic or heterocyclic group optionally substituted with one or more groups selected from C₁ to C₆ alkyl, —OH, —OR⁸, ═O, CO₂R⁸, —NR⁸R⁸, —NC(O)R⁸, —C(O)NR⁸R⁸, preferably R² and R³ are taken together with the carbon to which they are attached to form an optionally substituted 4 to 7-membered heterocyclic group, more preferably a 5-membered heterocyclic group;
R⁷ is selected from a direct bond, C₁ to C₆ alkylene, C₂ to C₆ alkenylene, and C₂ to C₆ alkynylene
R⁸ is independently selected from H, and C₁ to C₆ alkyl, wherein the C₁ to C₆ alkyl is optionally substituted with one or more of —OH, —CO₂H; epoxy and
R¹¹ and R¹² are independently selected from H, and C₁ to C₆ alkyl.

B may be defined by Formula (Y-II)

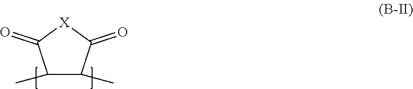

wherein X is selected from —O—, —NR⁸—, and —S—, preferably X is —O—; and
R⁸ is selected from H, and C₁ to C₆ alkyl.

Preferably, the copolymer is of Formula (II), more preferably the copolymer is of Formula (III).

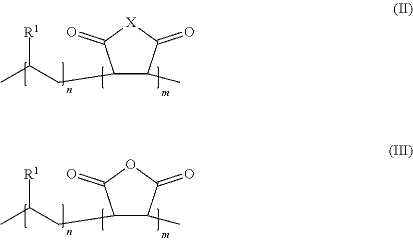

Also described herein is use of a primer composition for preparing an object for printing, wherein the primer composition comprises an amphiphilic copolymer comprising Formula (I)

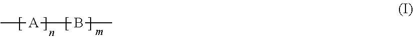

wherein A is a non-polar group;
B is a polar group; and
n and m are integers independently selected from 2 to 1,000,000.

In the apparatus or method described herein, applying a primer preferably comprises applying a primer as described above.

Also described herein is a cylindrical object comprising a protective surface coating with a layer of primer provided on top of at least part of the protective surface coating. Preferably, the layer of primer comprises the primer described above and herein.

The object may further comprise a surface decoration applied onto said layer of primer using a printing technique.

In the apparatus, method or object described herein, the printing technique is preferably an inkjet printing technique, and more preferably an electrostatic inkjet printing technique.

In the apparatus, method or object described herein, the cylindrical object is preferably a can, more preferably a two-piece can, and even more preferably a necked two-piece can.

In the apparatus, method or object described herein, the object is preferably formed from a metallic material, preferably aluminium or steel.

In the apparatus, method or object describe herein, the protective surface coating may comprise wax particles.

Also described herein is an object holding device for positioning a cylindrical object for use in an apparatus as described above, the device comprising: a first engagement member arranged to engage with a first end of the object; a second engagement member arranged to engage with a second end of the object; and a retaining assembly arranged to maintain the first and second engagement members in a spaced-apart and moveably opposed configuration, the first and second engagement members being moveable relative to one another so as to receive and retain an object therebetween.

Preferably, the first and second engagement members are rotatable such that rotation of one said first or second engagement members will cause a retained object to rotate together with the other of said first or second engagement members.

The retaining assembly may have an extendable telescopic configuration such that it may provide relative movement of the first and second engagement members so as to alter a spacing between them. The retaining assembly may be biased to move the second engagement member towards the first engagement member. The retaining assembly may further comprise a coiled spring that is arranged to be compressed as the retaining assembly moves the second engagement member away from the first engagement member.

The holding device may further comprise a fluid conduit in fluid communication with the first engagement member, wherein fluid may be introduced though the fluid conduit into a retained object via the first engagement member so as to pressurise the hollow interior of the object.

As will be recognised by a skilled person, numerous advantages over the prior art are provided by the inventive concepts disclosed herein.

Any apparatus feature described herein may be provided as a method feature, and vice versa. Moreover, it will be understood that the present invention is described herein purely by way of example, and modifications of detail can be made within the scope of the invention. Furthermore, it will be understood by the skilled person that particular combinations of the various features described and defined herein may be implemented and/or supplied and/or used independently.

### DESCRIPTION OF THE FIGURES

An embodiment of the present invention will now be described, as an example only, with reference to the accompanying drawings, in which:

FIG. 1 shows a necked can of the type referred to herein;

FIG. 1A shows the top of a necked can with a lid attached;

FIG. 2 shows a schematic apparatus for preparing a can for decorating therein, the apparatus having a plurality of processing stations through which a can may pass during treatment;

FIG. 3 shows a holding device for use in the apparatus of FIG. 2;

FIG. 4 shows a second view of the holding device;

FIG. 5 shows a neck engagement member for use in the holding device;

FIG. 6 shows a base engagement member for use in the can holding device;

FIG. 7 shows a schematic view of an arrangement of a cleaning station for the apparatus;

FIG. 8 shows a schematic view of an arrangement of a priming station for the apparatus;

FIG. 8A shows the arrangement of the priming station in a position for applying a primer to a can;

FIGS. 9A, 9B and 9C show three different views of an arrangement for drying primer applied on a can; and

FIG. 10A to 10E is a series of illustrations depicting various cross-sections of a can surface to show the order and build-up of different layers on a sidewall of the can.

### DETAILED DESCRIPTION

For clarity, not every feature is labelled in every figure, though any unlabelled features may of course be cross-referenced against the corresponding figures in which they are shown labelled.

Cylindrical Object

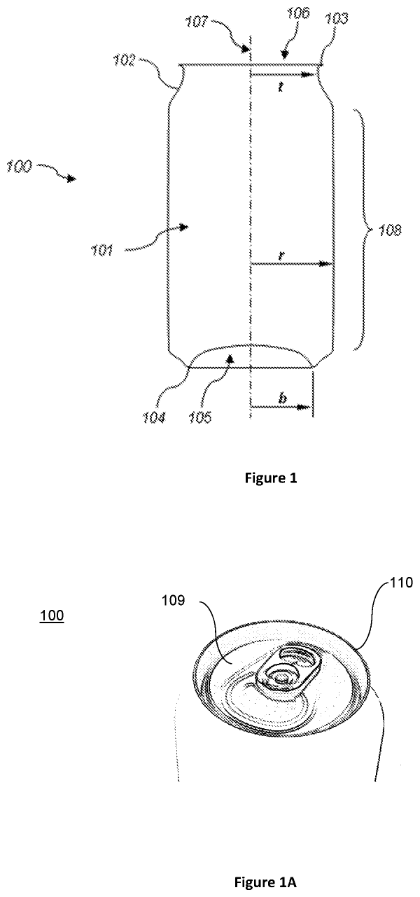

FIG. 1 shows an example of a cylindrical object in the form of a two-piece necked can 100, which embodiment will be used herein to describe the present invention. As will be understood, however, the present invention is not limited to necked cans.

The can 100 is shown in the form that it has before being filled and sealed. The can 100 is substantially cylindrical and is continuously symmetrical around a rotational axis 107. The can 100 comprises a cylindrical main body 101 having a substantially constant internal radius, r, along a middle portion 108 that forms the majority of the length of the can 100.

At a first, open (or “neck”), end of the can 100, the radius of the main body 101 tapers to a narrower neck portion 102, having an internal radius, t, smaller than that of the middle portion 108. The neck portion 102 terminates at a neck flange 103 that extends substantially radially from the neck portion 102 and has a substantially annular geometry. The neck flange 103 lies on a plane perpendicular to the axis 107 of the body 108 of the can 100. To seal the can 100 after being filled, the neck flange 103 is crimped with an interlocking lid portion (shown in FIG. 1A). In its unsealed state, the neck portion 102 and neck flange 103 define an opening 106 into the enclosed volume of the can 100.

At a second, closed (or “base”), end of the can 100, the main body 101 tapers to a protruding base ring 104, having a radius, b, smaller than the internal radius, r, of the middle portion 108. In this embodiment, the radius, b, is also smaller than internal radius, t, of the neck portion 102. The base ring 104 surrounds a concave domed portion 105 that closes the second end of the can 100. The base ring 104 forms a circular channel defined on its inner circumference by the concave domed portion 105 of the can 100, and on its outer circumference by the tapered portion of the second end of the main body 101 of the can 100.

Such cans 100 are well-known, and the above description is therefore provided simply for context. Such cans 100 are generally produced in a number of standard sizes including 33 cl and 50 cl, 12 oz and 16 oz. Many of these standard sizes have substantially the same internal radius, r, and therefore differ principally in the height of the middle portion 108 of the main body 101.

FIG. 1A shows an example of the upper part of a necked can 100 in the form that it takes after being filled and sealed with a lid 109 crimped to the neck flange 103 of the can 100. A protruding rim 110 is formed where the lid 109 is crimped to the neck flange 103.

Protective Surface Coating

Prior to necking, cans are coated with a hard and lubricious over print varnish (OPV) in order to protect and lubricate the thin (e.g. aluminium) walls through the necking process and subsequent transportation. Traditionally, this OPV also serves to protect printed surface decoration of the can 100 which is traditionally applied before necking and which would otherwise sustain damage in the necking process.

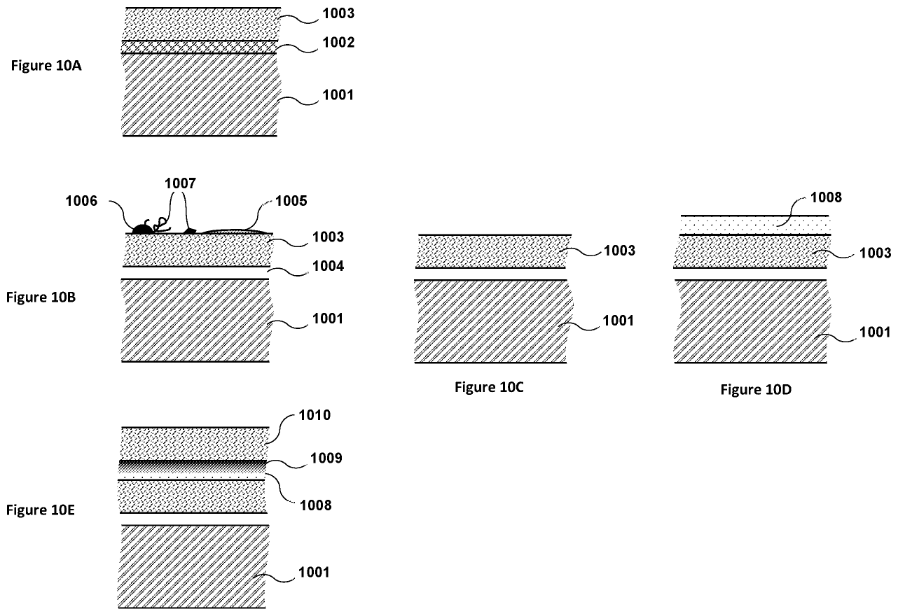

FIG. 10A shows a cross section of a can surface that has been decorated in the traditional way, wherein the wall 1001 forming the main body 101 of the can 100 first receives a printed decoration layer 1002 followed by a coating of an OPV layer 1003 to form a protective surface coating. The OPV layer 1003 covers the external surface of the main body 101, and typically also the neck portion 102, but not the base portion (e.g. the base ring 104) of the can 100. The hardness of the OPV layer 1003 is achieved by formulating the OPV to be thermally cross-linkable, resulting in a hard, impermeable surface of low surface energy, typically lower than 30 mN/m. The lubriciousness of the OPV layer 1003 is due to the use of high levels of waxy materials such as carnauba wax, polyethylene wax, PTFE waxes or similar.

These waxes are included in the OPV formulation as dispersed particles as they are insoluble in the carrier liquid. In the coated and thermally cured OPV layer 1003 these wax particles will be distributed throughout the coating thickness, often accumulating at the coating/air interface. As the resultant surface is contacted, these embedded wax particles can smear across the surface of the OPV layer 1003, reducing the coefficient of friction of the surface and favourably limiting abrasion. However, this smearing of the wax across the surface can significantly reduce the OPV surface energy. Thus, although the OPV is designed to protect the surface (of the can 100) that it covers, the surface that it presents to a now-desired, late-stage printing is very challenging because of its low and variable surface energy, impacting the wetting of subsequently applied fluids (such as inks) to decorate the surface of the can.

To further facilitate the necking process, the cans 100 have a food-grade lubricating oil or wax applied to the neck portion 102 before or during the necking process to ensure smooth transit through the necking machine. An example of such a lubricant is Paraliq P150 (from Kluber Lubrication). In contrast to the inherent lubrication in the OPV layer 1003, the externally applied lubrication can be present on the necked can 100 in varying amounts ranging from difficult-to-detect smears to macroscopic droplets.

It is normal for cans 100 to be stored and transported in open pallets with little protection from dirt or debris. Hence it is normal for the surface of a can 100 to collect particles and fibres of dirt and debris, and surface residues of necking oil are particularly prone to collect this further contamination. Such contamination is detrimental to the quality and reliability of a subsequent (e.g. inkjet) printing process.

FIG. 10B depicts the surface layers of a necked can 100 as described above, which is typical of cans manufactured, transported and received from a can manufacturer for late-stage decoration. Here the wall 1001 forming the main body 101 of the can 100 has been optionally coated with a layer of white pigment 1004 (which may be omitted if a metallic appearance is desired for the final printed can 100), over which the clear OPV has been applied and cured. On the surface of the OPV layer 1003 are smears of wax 1005 from the OPV, residues of necking oil 1006, fibres and particles of dirt and debris 1007.

Preparation Apparatus

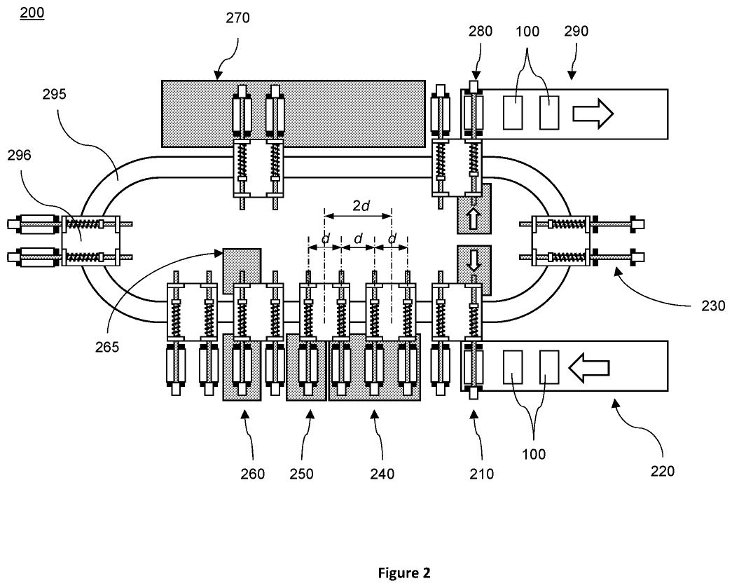

According to the present invention, in order to overcome the challenges presented by the protective surface coating on the necked can 100 and prepare the can 100 for being decorated thereon, the can 100 may undergo a series of operations or processes. In a preferred embodiment, the operations are performed in an apparatus 200 having a series of “stations”, as shown schematically in FIG. 2 and described in more detail below. It will of course be appreciated that the apparatus 200 described herein is simply an exemplary embodiment of a preferred apparatus for preparing a can 100 having a protective surface coating for decorating thereon (e.g. using a printing technique).

In the exemplary embodiment of an apparatus 200, shown in plan-view in FIG. 2, a can 100 arrives at a first “loading” station 210 in a transverse orientation such that the can 100 lies flat along its main body 101. The can 100 may be delivered to this first station 210 via a chute 220 along which it rolls due to gravity, for example. A holding device 230 engages the can 100 and transports it around the apparatus 200, initially from the can loading station 210 to a second, “cleaning” station 240. Here the can 100 is cleaned to remove surface contamination such as oil residues, dirt and dust from the protective surface coating (e.g. OPV) provided on the can 100. In this embodiment, a cleaning fluid is used during the cleaning operation, though in other embodiments of the can cleaning operation may not use a cleaning fluid. However, as a cleaning fluid is used here, the can 100 is subsequently transported to a third, drying station 250, at which residual liquid is removed from the surface of the can 100. FIG. 100 depicts the can surface at this stage in the process, with the surface contaminants (1005, 1006, 1007) depicted in FIG. 10B substantially removed as a result of the cleaning operation.

After being cleaned, the can 100 is transported to a fourth, “coating” (or “priming”) station 260, at which a coating (e.g. a primer composition) is applied to the surface of the can 100, as will be described in more detail further on. At the coating station 260, an empty can 100 may be pressurised to prevent deformation while being coated, for example when pressed against the coating roller. To this end, a can pressuriser 265 may be provided, which is arranged to supply compressed air into the can 100 at the coating station 260.

Once the coating is applied, the can 100 is transported through a “drying” station 270 comprising a tunnel arrangement where warm air is supplied to dry the coating that has been applied onto the can 100. Finally, the can 100 is released from the holding device 230 at a fifth, unloading station 280 and transported out of the treatment apparatus via an outfeed conveyor 290. FIG. 10D depicts the (new) surface of the can 100 at the end of the treatment (or preparation) process, in which the outer surface comprises a dried coating layer 1008 ready to receive printed decoration, for example.

In this exemplary embodiment, (can) holding devices 230 are located on a track system 295 that controls their motion between stations and defines their path of travel within the apparatus 200. The holding devices 230 are carried on carriages 296 that engage via bearings with the track 295 and which are linked together by a belt which is configured to drive the carriages 296 synchronously around the track 295. The belt may be driven by a single servo motor (not shown).

In FIG. 2, for convenience, each carriage 296 is shown carrying a pair of holding devices 230, though a single carriage 296 may alternatively carry a single holding device 230. In the preferred embodiment of the apparatus 200, the “pairs” arrangement is used to provide thirty-two holding devices 230 mounted, two per carriage 296, on sixteen carriages 296 (in FIG. 2 only a subset of carriages 296 is shown for clarity). The pair of holding devices 230 mounted on each carriage 296 are spaced apart a distance “d”. The sixteen carriages 296 are spaced apart equally on the belt a distance “2d”. Thus, at least on straight portions of the track system 295, the thirty-two holding devices 230 are spaced equally by a distance “d”. In operation, the carriages 296 are controlled to move in discrete movements of distance “d”.

In this example, the apparatus 200 is controlled to have a throughput of one can per second, and the process steps performed by the apparatus 200 have been developed to be compatible with this throughput. Hence the carriages 296 are controlled to move a distance “d” along the track in a first time period, then remain stationary for a second time period, the sum of the first and the second time periods equaling 1 second (or less). The second time period is greater than 0.5 seconds and preferably greater than 0.7 seconds. However, it will be understood that the scope of the present invention is not limited to these indicative timings.

The various aspects and stations mentioned above will now be described in more detail. Although the preferred apparatus 200 of FIG. 2 comprises a plurality of “stations”, as described above, the essential operations that prepare a can 100 for decorating thereon using a printing technique are performed at the coating (or priming) station 260 and the drying station 270. It will further be appreciated that the arrangement for transporting cans 100 between stations, mentioned above, and described in more detail below, is only a preferred embodiment.

Can Retention and Manipulation

In order to prepare a can 100, it must first be collected and retained in such a way that it may then be transported around the apparatus 200 and rotated during the various operations at the various stations.

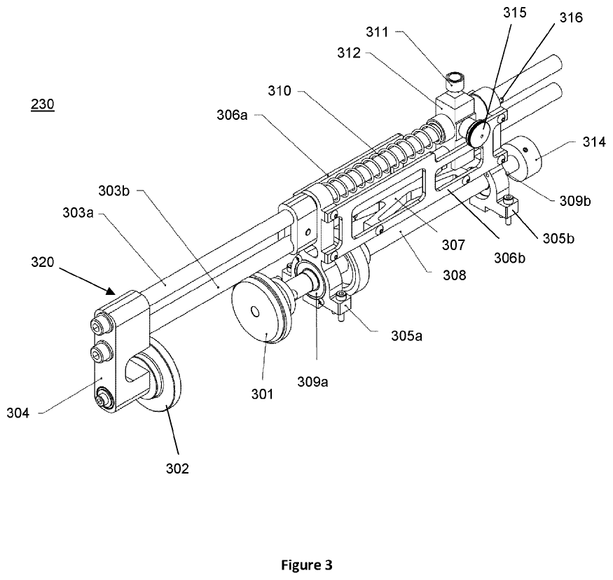

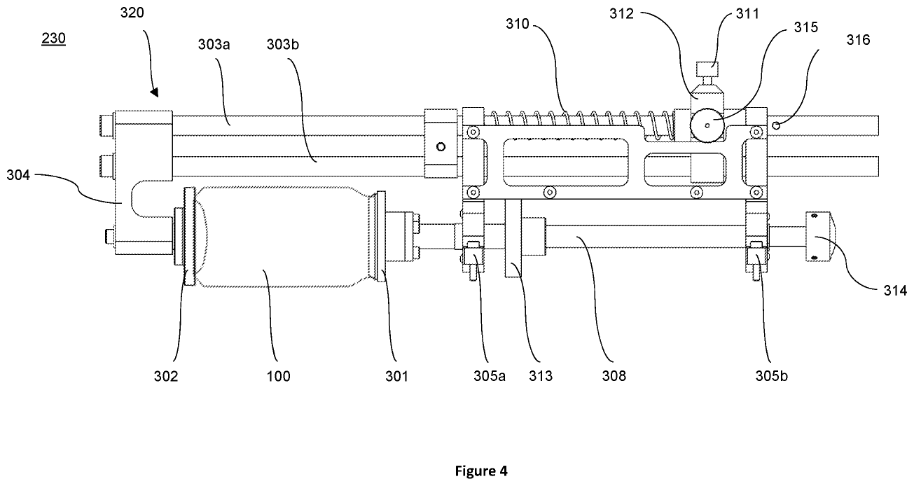

FIGS. 3 and 4 both show an example of a suitable holding device 230 for a can 100. The holding device 230 comprises first (“neck”) and second (“base”) engagement members 301, 302 arranged to engage with the neck end 102 and the base end 104 of the can 100, respectively, and thus retain it therebetween. The engagement members 301, 302 are spaced-apart via a telescopic retaining assembly 320 comprising two parallel arms 303a, 303b that are connected rigidly together by an end block 304 to which the base engagement member 302 is rotatably attached. The arms 303a, 303b each pass through two bearing housings 305a, 305b, through which the arms 303a, 303b slide. The bearing housings 305a, 305b are rigidly mounted to a base plate (not shown in FIG. 3) and are also rigidly tied together by two side supports 306a, 306b and a brace 307. The neck engagement member 301 is mounted on a shaft 308 that passes through bearings 309a, 309b in the bearing housings 305a, 305b respectively, such that the neck engagement member 301 and shaft 308 are together rotatable. The engagement members 301, 302 are hence moveably opposed and rotatable.

The retaining assembly 320 is extendable such that it can provide relative movement of the engagement members 301, 302 (i.e. can alter the spacing between them). The retaining assembly 320 is biased to move the base engagement member 302 towards the neck engagement member 301. The retaining assembly is preferably spring biased, for example via a coiled spring 310 that is compressed as the retaining assembly 320 moves the base engagement member 302 away from the neck engagement member 301.

A can 100 disposed between the engagement members 301, 302 will be retained securely in place by the bias force acting to move the engagement members 301, 302 towards each other. The length of the can 100 thereby defines an engagement position of the engagement members 301, 302 wherein the engagement members 301, 302 are biased against the neck 102 and base 104 of the can 100 respectively. In a release position, the engagement members 301, 302 are moved apart, thereby releasing the can 100.

An actuator (not shown) is provided at the can loading station 210, for example wherein the actuator comprises a moveable piston, arranged to engage with the retaining assembly 320 and to move it into the release position, in which it may receive a can 100. Once a can 100 is correctly positioned, the actuator may then allow the retaining assembly 320, via control of the actuator, to return to the engagement position to which is it biased. In the example of FIG. 3, the actuator is engageable with a cam follower 311 that is attached via a block 312 to the upper arm 303a to move the retaining assembly 320 into the release position.

The holding device 230 is preconfigurable for cans of a particular range of body height 108 by preselecting the location of the block 312 on the arm 303a. The location is defined by the engagement of a location pin 315 with one of at least one hole in the arm 303a. In the configuration shown in FIGS. 3 and 4, there are two possible locations of the block 312 on the arm 303a defined by two respective pin location holes in the arm 303a: the first, with the pin 315 engaged as shown, accommodates 33 cl and 12 oz can sizes and the second, with the engagement assembly 320 extended so that the pin 315 engages in the second hole 316, accommodates 50 cl and 16 oz can sizes.

The first engagement member 301 is rotatably attached to a friction wheel 313 via the shaft 308 that extends between them. The friction wheel 313 is arranged to engage with drive belts at each station of the apparatus, which thereby provide rotational drive to the friction wheel 313. Rotation of the friction wheel 313 drives rotation of the first engagement member 301, via the shaft 308, and hence a retained can 100. The second engagement member 302 is free to rotate such that it can rotate with the can 100.

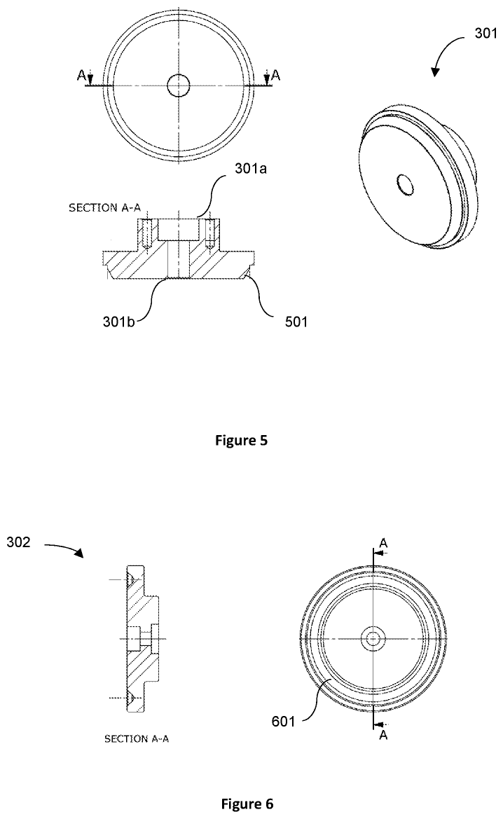

The shaft 308 is hollow, thereby providing a fluid conduit to the first engagement member 301. In this embodiment, configured for empty, open-necked cans, the first engagement member 301, shown in FIG. 5, both locates, by engagement with a conical (or chamfered) portion 501 of the first engagement member 301, and encloses the necked end 102 of the can 100 when in the engagement position as shown in FIG. 4. The shaft 308 is arranged to be received within an aperture 308a in the first engagement member 301 such that air can be blown into an engaged can 100 (e.g. to pressurise it) through a through-bore 308b of the first engagement member 301 via the shaft 308. The shaft 308 has a coupling 314 at its opposite end to which an air-line can be rotatably coupled for supplying air to the retained can 100 via the shaft 308, as will be described further on.

In an alternative embodiment configured for treating filled, lidded cans, the first engagement member 301 is adapted to locate the necked end of the can via the protruding rim 110 formed where the lid has been crimped onto the neck of the can. In this case, means of inflating the can are not used.

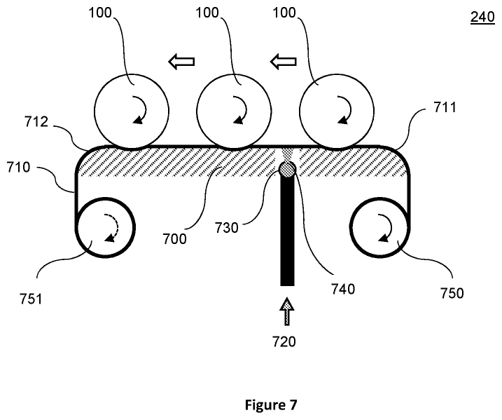

The second engagement member 302, shown in FIG. 6, comprises a disc with a recessed ring 601 (e.g. an annular groove) that corresponds in diameter to the protruding base ring 104 of the can 100, with which it locates in the engaged position as shown in FIG. 4.

Can Cleaning

To achieve a consistent and acceptable quality of decoration (e.g. print or coating) on the surface of the necked can 100, necking oil and other contamination must first be substantially removed from the protective surface coating (e.g. OPV) provided on the can 100 during its forming, discussed above. Also, if cans have been rubbing together during transport, then it is likely that wax particles on the layer of OPV coating will have smeared across the surface of the OPV layer in areas of contact and this waxy residue must also be substantially reduced for a subsequent applied liquid (e.g. ink used to decorate the can) to wet the surface of the can 100 uniformly.

Thus, prior to being able to decorate a necked can 100, it is first desirable to clean the protective surface coating to remove surface contaminants. This can be achieved using a cleaning material that is preferably wetted with a cleaning liquid. A suitable cleaning material is a cloth, preferably a “lint-free” cloth, an example of which is provided further on.

Cleaning Liquid

As noted above, the cleaning liquid should remove non-polar compounds from the surface of the can 100 to a level suitable for obtaining consistent and acceptable quality of decoration (e.g. print or coating) on the surface of a necked can 100. In addition to removing sufficient oil and wax from the surface of the can 100, the cleaning liquid may be used with the cloth to remove environmental contaminants (i.e. dust, fibres, aluminium powder) which may be on the surface of the can 100.

A suitable cleaning liquid may be an aqueous detergent solution or an organic solvent, or various mixtures thereof. Examples of suitable cleaning liquids include, but are not limited to, isopropyl alcohol, ethyl alcohol, butyl alcohol, aliphatic fluids and aromatic fluids. Preferably, the cleaning liquid is an organic liquid. Preferably, it is an aliphatic hydrocarbon (such as Isopar C) or isopropyl alcohol. Such solvents are preferred as they have a surface tension low enough to fully wet out the surface of a necked can 100 as this reduces the potential to form drying marks, which could negatively impact coating or print (i.e. decoration) quality. Other volatile or evaporable solvents (such as ethanol, butanol, 2-butoxyethanol, diacetone alcohols as well as other hydrocarbon solvents such as white sprits, benzene, toluene) can be used. In another embodiment, non-evaporable or low volatility solvents may be used as the cleaning liquid.

In an alternative embodiment, a suitable cleaning effect may be achieved by an aqueous detergent solution. A solvent, such as 2-butoxy ethanol, may also be used to enhance the cleaning effect.

Any non-evaporable component present in the cleaning liquid, either acquired from the protective surface coating being cleaned or present in the cleaning liquid as used, are undesirable due to the possibility for these non-evaporable materials re-depositing on the can surface and interfering with the subsequently deposited coating or printing fluids. Therefore, a (further) cleaning cloth may be used to remove droplets of such cleaning liquids.

Cleaning Apparatus

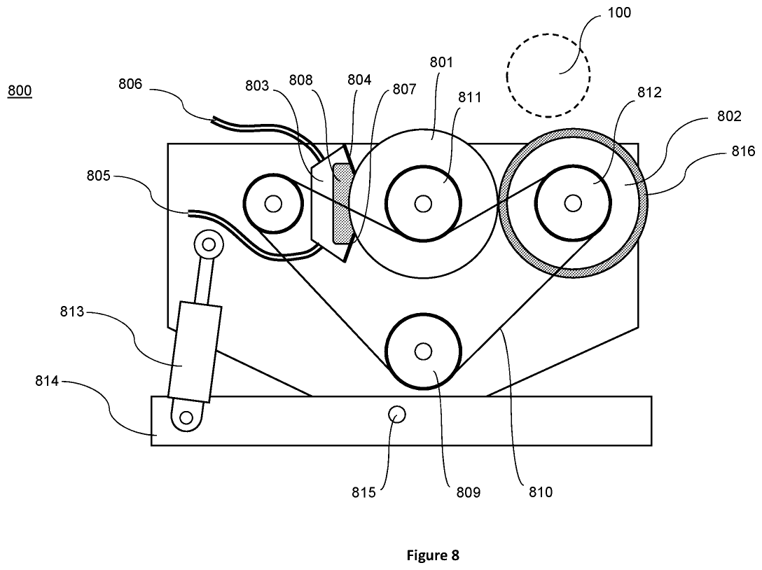

In this embodiment, as mentioned above, once a can 100 is retained by the holding device 230, it is moved to a “cleaning” station 240, shown schematically in FIG. 7, which performs the cleaning process described above. The cleaning station 240 comprises a substrate 700 upon which a cleaning material 710 is provided, against which a retained can 100 is held and rotated.

The cleaning material 710 is a fabric, and preferably a non-woven fabric. Ideally, the fabric is a lint-free cloth. An example of a suitable fabric is the DryPac™ cloth available from Baldwin Technology Company. In a preferred embodiment, a cleaning liquid 720 (such as described above) is applied to the cleaning material 710. Relative motion between the can 100 and the wetted cleaning material 710 (e.g. rotation of the can 100 against the cleaning material 710) removes residues of lubricant, wax and dirt from the protective surface coating of the can 100.

Here, the substrate 700 comprises a substantially flat (i.e. planar) surface. The surface must be compatible with the cleaning liquid 720 and preferably comprises a compressible material that is soft enough to compress slightly when in contact with the can 100 (i.e. the material is compressible relative to the can 100) to ensure a consistent contact area across the full height of the parallel sided part of the can body 108. The compression of the surface by the can 100 provides a restoring force that presses the cleaning material 710 against the can 100, and also increases advantageously the “wrap” length of the cleaning material 710 that is in contact with the can 100. This provides contact of the cleaning material 710 with the surface of the can 100 over an arcuate portion of its circumference, preferably up to 20% of its circumference.

The surface of the substrate 700 may comprise a closed-cell foam of PVC/nitrile rubber, preferably having a density of 40 to 100 kg/m³, more preferably 60 to 80 kg/m³. Rotation of the can 100 is backwards, i.e. such that the part of the surface of the can 100 in contact with the cleaning material 710 is moving in the same direction as the discrete movements of the holding device 230. This leaves debris, transferred from the can 100 to the cleaning material 710, behind the can 100 as it moves out of the cleaning station 240 so that it does not impinge on the surface of the can 100. Rotation of the can 100 is provided by the engagement of the friction wheel 313 of the holding device 230 with a drive belt at the cleaning station 240, the drive belt maintaining engagement with the friction wheel 313 from when the can 100 enters, to when it leaves, the cleaning station 240.

The cleaning liquid 720 is dosed onto the underside of the cleaning material 710 via a solvent conduit 730 which extends across a gap in the substrate 700 that is substantially the width of the cleaning material 710. The conduit 730 has one or more holes 740 provided along its surface that are arranged to direct the cleaning liquid 720 onto the cleaning material 710. A controlled amount of cleaning liquid 720 is periodically sprayed onto the cleaning material 710 in order to keep the cleaning material 710 damp, but not excessively wet. The conduit 730 is supplied by a dosing pump from a reservoir (not shown).

The cleaning material 710 may be arranged on two rollers 750, 751, such that a portion of the cleaning material 710 can extend therebetween, which is then provided on the substrate 700 for cleaning the can. The rollers 750, 751 can be controlled to change the portion of cleaning material 710, i.e. with a first roller 750 being arranged such that, when rotated, it gathers up a used portion of the cleaning material 710, with the second roller 751 being free to rotate such that as the first roller 750 rotates it drives rotation of the second roller 751 to release a fresh portion of the cleaning material 710 onto the substrate 700. The rollers 750, 751 are ideally located at opposing sides of the substrate 700 for convenience.

Can Drying

In a preferred configuration, the cleaning material 710 is moved over the substrate 700 in the opposite direction to the travel of the can 100, and the conduit 730 is positioned part way along the substrate 700. This results in a first portion 711 of the cleaning material 710 that the can encounters being wet with cleaning liquid 720, and a second portion 712 of the cleaning material 710 it encounters being substantially dry. The cleaning process is hence divided into a first, “wet wipe” that cleans the can 100, followed by a second, “dry wipe” that dries the can 100. In tests, the best result was obtained when the “dry wipe” was approximately twice the duration of the “wet wipe”. Rotation of the can 100 against this dry portion 712 of cleaning material 710 dries the cleaned surface of the can 100.

Additionally, or alternatively, the can 100 is then moved to a position over an air blade (not shown), which further helps to ensure that the can 100 is dry by blowing air over the can 100 as it is rotated.

Collectively (or individually), this arrangement may be referred to as a third “can drying” station 250.

Can priming Once the can 100 has been cleaned and dried, a primer composition is then applied to the main body 101 of the can 100. In this embodiment, the holding device 230 transports the can to a fourth, “priming” station 260 in order to do so. A suitable method of applying a primer to the body 101 of the can 100 is by a “transfer roller” arrangement. The priming station 260 in this embodiment comprises an offset gravure coating arrangement having a chambered doctor blade system; this coating technique is known in the art and is summarised below.

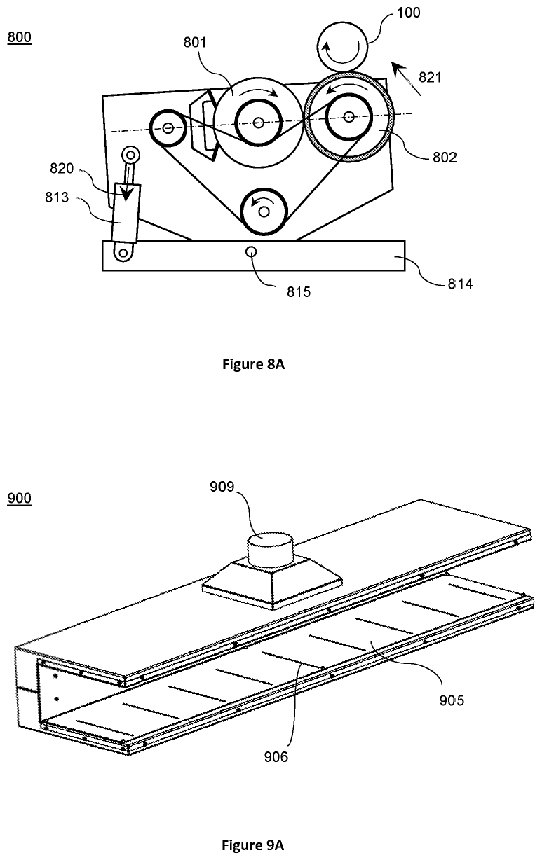

With reference to FIG. 8, the priming station 260 comprises a gravure cylinder 801 and a transfer roller 802. The transfer roller 802 is arranged to apply primer to the retained can 100. The transfer roller 802 is arranged to receive primer from the gravure cylinder 801, with which it is in contact.

The gravure cylinder 801 has a rigid surface comprising an engraved pattern of cells of a specified width and depth, distributed uniformly over the circumference of the cylinder 801. The engraved area occupies a central width portion of the cylinder 801 that corresponds to the desired width of the body of the can 100 to be coated, either side of which the surface of the cylinder 801 is smooth.

The gravure cylinder 801 receives primer liquid contained in a chamber 803 positioned adjacent the gravure cylinder 801, which chamber is closed on one side by the surface of the gravure cylinder 801. As the gravure cylinder 801 rotates, its surface becomes coated with primer in the chamber 803, filling the cells formed in its surface. Excess primer is removed from the surface of the gravure cylinder 801 by a metering doctor blade 804 extending in an axial direction of the gravure cylinder 801, such that the majority of the primer liquid retained on the cylinder surface is contained in the cells. Hence, the cell dimensions and distribution define a capacity of the gravure cylinder 801, and determine the amount of primer liquid that is delivered by the gravure cylinder 801 to the transfer roller 802. Preferably, the capacity of the gravure cylinder 801 is between 10 and 50 cc/m² and more preferably 35 cc/m².

Primer is supplied to the chamber 803 via a supply tube 805 from a remote reservoir (not shown) by a pump (not shown), which provides a circulation of primer from the reservoir to the chamber 803 and back to the reservoir via a return tube 806. The chamber 803 is sealed to the rotating gravure cylinder 801 by the metering doctor blade 804 on the upper edge, a containment doctor blade 807 on the lower edge, and a foam seal 808 at each side edge of the chamber 803. The foam seals 808 bear against the smooth surface of the cylinder 801 either side of the central engraved portion.

The transfer roller 802 is mounted axially parallel to the gravure cylinder 801 on a moveable mounting that enables adjustment of the contact pressure between them. The gravure cylinder 801 and transfer roller 802 rotate in opposite directions and are configured to rotate with the same surface velocity at their line of contact. The cylinder 801 and transfer roller 802 are conveniently both driven from a single drive motor (not shown) via a first, driving pulley 809 and a single toothed belt 810 that engages with a second pulley 811 and a third pulley 812 attached to the shafts of the gravure cylinder 801 and the transfer roller 802, respectively.

This coating arrangement is controllable to move between a first position, in which the transfer roller 802 is in contact only with the gravure cylinder 801 (FIG. 8), and a second position, in which the transfer roller 802 maintains contact with the gravure cylinder 801 but also comes into contact with the retained can 100 (FIG. 8A) In this example, the movement between the first and second positions is driven by an actuator 813, which pivots the apparatus relative to a base mounting plate 814 about a fulcrum 815 to produce a rocking motion of the coating apparatus as depicted by the arrows 820, 821. Thus, in use, the retained can 100 is held in a predetermined position relative to the transfer roller 802 in the first position, preferably above the transfer roller, which is then moved, by the actuator 813, from the first position to the second position in which the surface of the transfer roller 802 comes into contact with a can 100 positioned here by the holding device 230.

Contact between the retained can 100 and the transfer roller 802 when in the second position causes primer to be transferred from the transfer roller 802 onto the surface of the can 100. The can 100 is rotated in the opposite direction to the transfer roller 802, as shown in FIG. 8A, so that the surfaces of the can 100 and the transfer roller 802 are moving in the same direction at their line of contact. Rotation of the retained can 100 is provided via another drive located at the “priming” station 260, which is arranged to engage the friction wheel 313 of the holding device 230.

The angular rotation of the retained can 100 is controlled independently of the speed of the transfer roller 802. Typically, it rotates with a surface speed of at least two, and more preferably three, times faster than that of the transfer roller 802 (i.e. the “draw speed” of the can 100 relative to the transfer roller 802 is at least 2 and preferably 3). The resulting shear at the contact line between the transfer roller 802 and the can 100 smooths out the primer around the surface of the can 100 and thereby helps to avoid any distinct “join” lines showing where application of the primer to the retained can 100 starts and stops.

A surface layer 816 of the transfer roller 802 is compliant so that it contacts the can 100 with a substantially uniform pressure across its entire length. The side wall 108 of a necked can 100 typically has “high” points where the side wall 108 meets the chamfered neck 102 and base 104 regions and, without some compliance, the transfer roller 802 would exert a much higher pressure on these “high” points than elsewhere across the surface of the can 100, resulting in an uneven coating. The surface layer 816 of the transfer roller 802 is preferably nitrile rubber, preferably having a hardness of between 20 and 40 shore, and more preferably about 30 shore.

The primer is only applied to the parallel-sided portion 108 of the main body 108 of the can 100, which is the part of the can 100 that will be decorated (e.g. printed on), subsequently, using the intended printing technique.

In this embodiment, which is configured for empty, open-necked cans, while the primer is being applied, the retained can 100 is pressurised by compressed air being supplied into the can 100 via the hollow shaft 308 to provide the can 100 with a positive internal pressure. This helps to reinforce the main body 108 of the can 100 against distortion from the pressure of the transfer roller 802, and keeps the can 100 in uniform contact with the transfer roller 802 across its full width to provide an even coating of primer onto the surface of the can 100. Thus, once the retained can 100 has been moved into position by the holding device 230, a rotatable air coupler (mentioned above) is advanced into position and coupled with the shaft 308 via the air coupling 314 to supply pressurised air of, preferably, 0.3 to 0.7 bar, more preferably 0.5 bar, into the retained can 100. In an alternative embodiment configured for treating filled, lidded cans, the step of pressurising the can 100 is redundant and omitted.

Primer drying Once the primer has been applied to the can 100, it needs to be dried before it is ready to be decorated. It is also important that the primer coating is dried to a solid layer 1003 prior to releasing the can 100, to prevent damage to the coating occurring once the can 100 is released from the apparatus 200, for example into a conveying apparatus between the primer coating apparatus and a subsequent printing apparatus.

Drying is preferably performed using heated air directed at the surface of the can 100 to accelerate evaporation of the liquid components of the primer coating. This can be achieved by passing the retained can 100 through a drying tunnel comprising a series of air “blades” which direct heated air at the surface of a “primed” can 100 as the can 100 is rotated. In tests, effective drying of the primer resulted from air directed at the surface of a can 100 with a velocity of between 10 and 18 m/s at a temperature of greater than 30° C. for a time of at least 5 seconds, and preferably at least 8 seconds. Preferably the air temperature is between 30° C. and 80° C.

In this embodiment, a warm air tunnel is provided at a fifth primer “drying” station 270 to which the retained can 100 is again moved by the can holding device 230. The retained can 100 is rotated by another drive belt and moved through the warm air tunnel in a series of discrete movements as it rotates, aligning between each movement with a respective air blade.

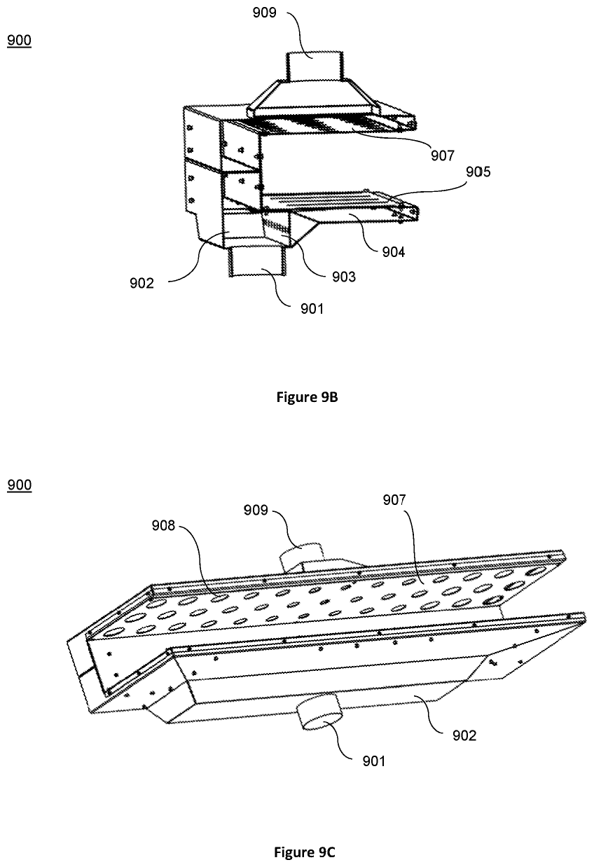

FIGS. 9A, 9B and 9C show three different views of a suitable drying tunnel 900. As seen in FIG. 9B, the tunnel 900 is C-shaped in section, having a slotted floor 905 for directing air at a can 100, and a perforated ceiling 907 for extracting air from the tunnel 100, between which the cans 100 to be dried are passed. An air inlet 901 in the underside of the tunnel 900 communicates with a plenum chamber 902 that extends over most of the length of the tunnel 900. A baffle plate 903 separates the plenum chamber 902 from a second chamber 904 and comprises an array of holes through which the heated air passes into the second chamber 904. The roof of the second chamber 904 also forms the floor 905 of the tunnel 900. The tunnel floor 905 comprises plural slots 906 cut in a direction perpendicular to the length of the tunnel 900 and parallel to the axis of the cans 100 that are passed through the tunnel 900. The slots 906 are spaced apart a distance “d”, equal to the spacing of holding devices 230 on the track, and are substantially the same length as the body of the largest size can 100 to be used in the apparatus. In this example, there are nine slots 906 each measuring 175 mm long by 3 mm wide.

The air inlet 901 is connected via a pipe to a blower and a heater so that, in use, heated air is blown into the inlet 901 and exits the slots 906, thus creating the air “blades”. A suitable blower is the RT-2200/3 from Airtec Systems, specified to deliver an airflow of up to 5.2 m³/min. A suitable heater is the FT600 Flow Torch, a 60 kW air heater from Farnham Custom Products. The combination of the plenum chamber 902, the baffle plate 903 and the second chamber 904 substantially equalises the pressure of the air along and across the drying tunnel to spread the air flow from the slots 906 evenly. Cans 100 held by respective holding devices 230 are moved in discrete movements through the drying tunnel 900, stopping in line with the slots 906, where the heated air is directed on to the full length of the coated (i.e. “primed”) surface of the can 100 as it is rotated. Multiple cans 100 at a time may be dried in the drying tunnel 900.

Air is extracted through the holes 908 in the ceiling 907 of the drying tunnel 900 by an extractor fan connected to an air outlet 909. The holes 908 vary in size from the middle of the tunnel, where they are smallest, to the ends of the tunnel 900, where they are largest, to compensate for an increased resistance to flow from the ends of the tunnel 900 compared to the centre, thus to produce a substantially even extraction rate along the length of the tunnel 900. The total extraction rate is set to be equal or greater than the rate of air supply to the tunnel 900 to minimise spill-out of heated air from the tunnel 900. A suitable extractor is the TB0400 from Airtec Systems, specified to produce an air flow of up to 6 m³/min, for example.

Releasing the can Once the primer has dried onto the can 100, the prepared can 100 is ready to be decorated and is moved by the holding device 230 to a release position, where the can is released. In this embodiment, this occurs at a sixth, “release” station 280, where a further actuator is provided for moving the retaining assembly 320 of the holding device 230 to the release position thereby separating the engagement elements 301, 302 so that the can 100 is released. The can 100 is released, still in transverse orientation, onto a descending track 290 that allows the can 100 to be removed from the apparatus 200. One or more air nozzles may be positioned over the track 290 and orientated towards the direction from which a can 100 will move down the track 290, under gravity. In this way, air can be used to slow down the movement of the cans 100 to avoid damage from adjacent cans 100 coming into contact on the track 290.

As previously noted, it will be appreciated that the apparatus 200 and stations described herein are simply exemplary embodiments of a preferred apparatus and stations for performing the necessary method steps for preparing a can 100 for decorating thereon, preferably using a printing technique.

Subsequent Printed Decoration

A can 100 that has been prepared by the above method and/or apparatus is ready to receive printed decoration thereon. A variety of printing methods may be employed to decorate the can 100, but most advantageous and suitable for late-stage short-run printing are digital printing methods because of their capability to print variable image content. Such printing methods include drop-on-demand inkjet, comprising aqueous, solvent-based or UV-curable ink types. Particularly suitable is electrostatic inkjet printing of the Tonejet™ type, well known in the art and described in, for example, U.S. Pat. Nos. 6,905,188, 9,156,256 and 8,845,082.

This printing process comprises the ejection of highly-pigmented ink from plural printheads, each printhead ejecting a single colour ink, to form a process-colour image on the substrate before the application and curing of a clear OPV to fix and protect the printed image. Such inks typically have a carrier liquid of Isopar, a refined isoparaffinic solvent. As described below, the primer layer 1008 is designed to rapidly absorb the ink to prevent inter-colour bleeding. Hence, as depicted in FIG. 10E, the inks 1009 are absorbed into the primer layer 1008 on the surface of the can. Most of the ink carrier liquid is then evaporated, leaving mostly the pigments in place, before application of a clear OPV 1010 by, for example, an offset gravure method. Following a final OPV curing process the printed, necked can has the surface layer build-up depicted in FIG. 10E.

The above-mentioned printing operation may be carried out in a separate apparatus, separate to the present invention, but optionally connected thereto by a suitable conveying apparatus, as mentioned above. Suitable apparatus for handling and decorating (e.g. printing) necked cans is described in WO 2018/083164, WO 2018/083167, WO 2018083163 and WO 2018083162, for example.

Primer Composition

The primer composition comprises an amphiphilic copolymer comprising Formula (I):

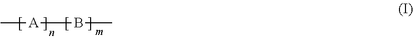

wherein A is a non-polar group;
B is a polar group; and
n and m are integers independently selected from 2 to 1,000,000.

An amphiphilic copolymer is a polymer that has both hydrophilic and lipophilic properties. This term is well-understood in the art. The primer composition according to the present invention, comprising an amphiphilic copolymer, is advantageous as it can rapidly absorb ink and swell to prevent inter-colour bleeding of the ink, whilst also adhering to the surface of the OPV layer on the can. Furthermore, such polymers form hard, non-tacky layers which resist mechanical impact and abrasion (which may occur during transfer of the can through the printing process).

The term “copolymer” is one of the art. It refers to a polymer comprising two or more different monomer units that are polymerised in a process called copolymerisation. Since a copolymer comprises at least two different monomer units, copolymers can be classified based on how the monomer units are arranged to form a polymer chain. Those classifications include “alternating copolymers” (in which the monomers units repeat with an regular alternating pattern), “periodic copolymers” (in which the monomers units are arranged with a repeating sequence), “statistical copolymers” (in which the sequence of monomer units follows a statistical rule), “random copolymers” (in which the monomer units are attached in a random order), and “block copolymers” (in which two or more homopolymer subunits are linked).

It will be apparent to those skilled in the art that the nomenclature used in, for instance, Formula I does not denote the type of copolymer, i.e. a block copolymer, alternating copolymer, periodic copolymer, statistical copolymer or random copolymer.

The copolymer useful in the invention may be any copolymer type. However, it is preferred that it is an alternating copolymer.

Ratio of n to m may be changed to tune the properties of the polymer to suit the particular application.

A is a non-polar group that is soluble in a solvent with aliphatic non-polar chains (i.e. the ink carrier liquid). B is a polar group for adhering to the OPV network (i.e. the surface on the can to which the primer is being applied). By having both polar and non-polar functionality, the primer composition is able to adhere to the OPV surface of the can, and ensure that ink compositions having aliphatic non-polar carrier liquids can be printed onto the primer layer.

In a preferred embodiment, A is defined by Formula (A-I)

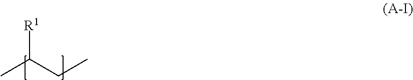

wherein R¹ is selected from the group consisting of
i. Hydrogen
ii. C₁ to C₄₀ alkyl, preferably C₁₂ to C₂₅ alkyl;
iii. C₂ to C₄₀ alkenyl, preferably C₁₂ to C₂₅ alkenyl;
iv. C₂ to C₄₀ alkynyl, preferably C₁₂ to C₂₅ alkynyl,
v. C₆ to C₄₀ aryl;
   wherein the alkyl, alkenyl, alkynyl and aryl are optionally substituted with halo;
   most preferably R¹ is C₁₂ to C₂₅ alkyl.

The C₁ to C₄₀ alkyl may be linear, branched, cyclic or partially cyclic.

The C₂ to C₄₀ alkenyl may be linear, branched, cyclic or partially cyclic.

The C₂ to C₄₀ alkynyl may be linear, branched, cyclic or partially cyclic.

The C₆ to C₄₀ aryl may be a monocyclic, bicyclic, or tricyclic monovalent aromatic radical, such as phenyl, biphenyl, naphthyl, anthracenyl, which can be optionally substituted with up to five substituents preferably selected from C₁-C₆ alkyl.

Halo preferably is F, Cl and Br.

In a preferred embodiment, B is defined by Formula (B-I)

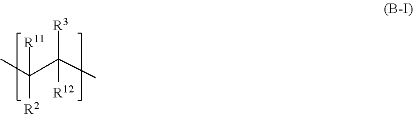

wherein R² and R³ are independently selected from the group consisting of H, halo, —R⁷—OR⁸, —R⁷═O, —R⁷—CO₂R⁸, —R⁷—NR⁸R⁸, —R⁷—NC(O)R⁸, —R⁷—C(O)NR⁸R⁸, wherein at least one of R² and R³ is not H, or
R² and R³ are taken together with the carbon to which they are attached to form a 4 to 7-membered cyclic or heterocyclic group optionally substituted with one or more groups selected from C₁ to C₆ alkyl, —OH, —OR⁸, ═O, CO₂R⁸, —NR⁸R⁸, —NC(O)R⁸, —C(O)NR⁸R⁸, preferably R² and R³ are taken together with the carbon to which they are attached to form an optionally substituted 4 to 7-membered heterocyclic group, more preferably a 5-membered heterocyclic group;
R⁷ is selected from a direct bond, C₁ to C₆ alkylene, C₂ to C₆ alkenylene, and C₂ to C₆ alkynylene
R⁸ is independently selected from H, and C₁ to C₆ alkyl, wherein the C₁ to C₆ alkyl is optionally substituted with one or more of —OH, —CO₂H; epoxy and
R¹¹ and R¹² are independently selected from H, and C₁ to C₆ alkyl.

The C₁ to C₆ alkylene is a divalent alkane. The C₂ to C₆ alkenylene is a divalent alkene. The C₂ to C₆ alkynylene is a divalent alkyne.

Preferably, B is defined by Formula (Y-II)

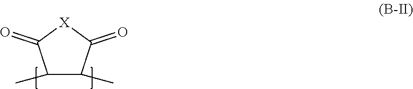

wherein X is selected from —O—, —NR⁸—, and —S—, preferably X is —O—; and R⁸ is selected from H, and C₁ to C₆ alkyl.

In a preferred embodiment, the copolymer is of Formula (II), more preferably the copolymer is of Formula (III).

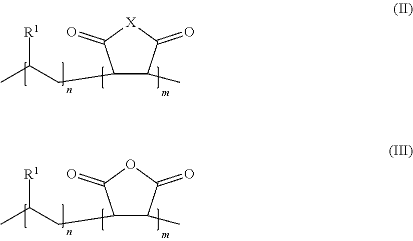

In a preferred embodiment, the copolymer has a ratio of n:m from 0.8:1.2 to 1.2:0.8, preferably 0.9:1.1 to 1.1:0.9, more preferably about 1:1. Preferably the ratio of n:m is about 1:1 and the copolymer is an alternating copolymer.

The integers n and m are selected from 2 to 1,000,000. Preferably, they are selected from 5 to 800,000, more preferably 10 to 500,000.

In a preferred embodiment, the copolymer is of Formula (III)

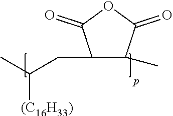

and wherein p is an integer selected from 2 to 1,000,000

The copolymer useful in the invention may have a molecular weight of from about 1,000 to about 100,000 gmol⁻¹, for example from about 2,000 to about 60,000 gmol⁻¹, such as from about 20,000 to about 50,000 gmol⁻¹. The molecular weight of a copolymer may be measured by Gel Permeation Chromatography (GPC) against a polystyrene standard.

Copolymers useful in the present invention are commercially available, such as poly(octadecyl-co-maleic acid anhydride (also known as “2,5-furandione, polymer with 1-octadecene”) available from Chevron Phillips under the product name PA-18 (CAS 25266-02-8). Alternatively, they may be synthesised from functionalised alkene monomers. Those monomers may be reacted in the presence of a free-radical initiator, such as azobisisobutyronitrile (AIBN) or benzoyl peroxide, under suitable conditions, such as those useful to make polystyrene, as shown in the following reaction.

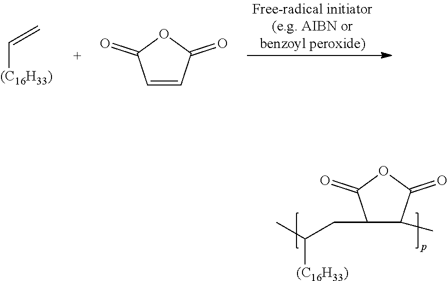

The copolymer may be used as part of a polymer blend in which different polymers/copolymers are combined. This helps to tune the properties of the polymer blend to the particular application.

The primer layer may be required to survive mechanical abrasion of the surface before printing. Therefore, the primer composition according to the present invention may also comprise a reinforcing pigment. It may be present in the range of 0.1 to 5 wt % of the primer composition.

The term reinforcing pigment refers to an inert pigment that, due to its particle size, is capable of reinforcing the primer composition once it is applied as a layer to the can. This prevents surface marking and damage during production, and makes the layer more mechanically robust. By “inert” it is meant that the pigment is insoluble in the non-polar aliphatic ink carrier liquid.

The primer composition according to the present invention may also comprise a primary solvent. The primer composition may also comprise a secondary solvent, which is compatible with the primary solvent.

The primary solvent may be 50 wt % to 100 wt % of the total solvent in the primer composition, preferably 60 wt % to 80 wt %. The secondary solvent may be 0 wt % to 50 wt % of the total solvent, preferably 20 wt % to 40 wt %.

In one embodiment, the primary solvent is an aliphatic hydrocarbon, such as Isopar G and the secondary solvent is a polar solvent, such as 1-butanol, pentyl propionate or ethyl 3-ethoxypropionate. In an alternative embodiment, the primary solvent may be a polar solvent such as 1-butanol, pentyl propionate or ethyl 3-ethoxypropionate.

The invention also relates to use of a primer composition as described above for preparing an object for printing.

### EXAMPLES

Preparation of primer compositions: all components were mixed together at the ratios exemplified in Table 1 and then high-shear mixed to give primer formulations EX1 to EX9. All numerical values in Table 1 indicate % by mass.

The used materials are as follows:—
Isopar G—a refined isoparaffinic solvent with a boiling range between 161° C. and 173° C., manufactured by ExxonMobil Chemical
Butan-1-ol, butanol, ordered from Sigma-Aldrich-Merck
IPA—Isopropyl alcohol, ordered from Sigma-Aldrich-Merck
DAA—Diacetone alcohol, ordered from Sigma-Aldrich-Merck
PP—Pentyl propionate, ordered from Sigma-Aldrich-Merck
EEP—Ethyl 3-Ethoxypropionate, manufactured by Eastman Solvents
Laropal A81—Condensation product of urea and aliphatic aldehydes, Manufactured by BASF
NeoCryl B-875—solid acrylic copolymer with affinity of aliphatic solvents, manufactured by DSM Coating Resins B.V.
Pilloway Ultra 350 LV—aliphatic compatible vinyl acrylic copolymer, manufactured by OMNOVA Solutions
PMAO—poly(maleic acid anhydride-co-octadecene), ordered from Sigma-Aldrich-Merck
Ceraflour 1000—biodegradable, micronized polymer with wax-like properties, manufactured by BYK Additives
TiO2—Tronox CR 828 white Titanium dioxide pigment
Ceracol 609N—Dispersion of wax-modified lanolin for solvent-borne can coatings, manufactured by BYK additives
Acematt 3600—Fine-grained polymer-treated silica, manufactured by Evonik

Evaluation of Printed Image Quality

The primer layer composition was applied to a necked can using an offset gravure technique, following a solvent wipe step to remove necking oil. A test image was then printed on to this can using Tonejet™ printheads and inks. The image comprised solid blocks of cyan, magenta and yellow, in which were included various point sizes of negative text. In addition, there were solid blocks of blue, red and green also including various point sizes of negative text. Finally, there was a solid block of three colour black (cyan+magenta+yellow), and a black ink under printed with 50% of cyan, magenta and yellow, also including the different point sizes of negative text.

Evaluation Criteria:

A: Sharp 4 point negative text and crisp images across all colour blocks

B: Some unreadable levels of 4 point negative text across some colour blocks

C: Unreadable 4 point negative text across all colour blocks

Formulations EX1, 2, 3 and 4 examine the use of different polymers as the ink absorbing primer layer component. The Neorez B-875 and Plioway Ultra 350LV (EX2 and EX3) are polymers that are compatible with the ink carrier fluid (Isopar G) and both show excellent printed image quality although at the expense of OPV adhesion. This poor adhesion performance is assumed to be due to the non-polar nature of these polymers resulting in the materials not interacting with the relatively polar OPV composition. In comparison, the more polar Laropal A81 polymer (EX1) is not compatible with the ink carrier and so shows poor printed image quality as the ink is not absorbed and controlled. However, this polymer does show good OPV adhesion, presumably due to the more polar nature of this polymer interacting more strongly with the polar OPV chemistry.

Finally, the poly(maleic acid anhydride-co-octadecene polymer (EX4) is both compatible with the ink carrier and has both a polar component (maleic acid anhydride) and a non-polar component (octadecene). As can be seen in Table 1, this material shows both good printed image quality and good OPV adhesion

Evaluation of Coating Aging Stability

The primer layer composition was filled into a suitable plastic container and left at room temperature for one week. The sample was then gently shaken for 30 seconds before testing as below.

Evaluation Criteria:

A: No obvious viscosity difference after storage and all sediment, if present, fully dispersed

B: Slight viscosity increase after storage and/or a sediment remaining that is fully dispersible after vigorous shaking

C: Large viscosity increase or gelling after storage and/or non-dispersible sediment

EX4 demonstrates poor coating stability due to the propensity of this formulation to gel over time. It is proposed that this gelling is due to an interaction of the polymer's polar groups in the Isopar G solvent over time. Therefore, it was proposed that this gel could be disrupted by the addition of an Isopar G compatible alcoholic solvent to interact with the polymer's polar groups and thus prevent their interaction and the resultant gelling. EX5 uses diacetone alcohol as the Isopar G compatible solvent giving a primer composition with good stability and no propensity to gel.

Evaluation of Coating Robustness to Machine Handling

In some implementations, the cleaned and primer coated cans would have the next layer of decoration immediately applied without removing the can from whatever jig or apparatus was used to hold the can. In other implementations, the can would have the primer coating applied to the can, dried and then released from the can holding jig into a can transport system to transport to the next process stage. This can transport system may involve can lifts and slopes in which the cans roll down towards the next stage of the process. Necessarily, such a can transport system involves surface contact and so the applied primer layer must be robust enough to resist this with no impact on the image quality of the subsequently applied fluids.

To evaluate the coating robustness the cans were first coated using an offset gravure process and dried. The cans were then initially tested using a gloved thumb twist to examine the hardness and tackiness of the coating. If the coating passed this then it was manually loaded into a can transfer chute comprising inclined rails and allowed to roll down into the loader of the next (printer) stage.

Evaluation criteria for coating robustness:—

A: Pass inclined rail test without any surface defects noticeable in the coating or in the final printed image

B: Pass thumb twist rub test but fails the inclined rail test

C: Fail thumb twist test

The robustness of the primer coating is mainly controlled by the hardness and robustness of the primary polymer component with EX1 and EX3. However, the soft PMAO in EX4 is easily smeared with the thumb twist test. As shown in EX6, this performance can be significantly improved with the addition of large pigment particles such as Ceraflour 1000. It is presumed that this improvement in the mechanical robustness is due to a reinforcing effect from the hard pigment particles, as well as surface slip enhancement. Furthermore, the addition of hard pigment particles can be used to simultaneously add other functionality such as whiteness, as in EX9, in which titanium dioxide is used as the reinforcing agent.

Evaluation of OPV Adhesion

The primer layer composition and Tonejet™ digital print was applied as described in the Evaluation of Printed Image Quality experimental section above. A commercially available beverage can over print varnish (Aquaprime 105 from Akzo Nobel) was then applied to this primed and printed can using an offset gravure coating process. This coating process was optimised to ensure dry OPV film weights (baked) were 80-100 mg per 330 ml can.

The adhesion testing was then conducted on flattened cans by creating two perpendicular cuts with a crosscutting tool to create a 1 mm grid in the OPV layer. Scotch 610 tape was applied over the grid, aligned parallel to one set of cuts, and rubbed firmly with a fingernail to remove any air bubbles and ensure tape adhesion. Tape was then removed by pulling backwards at a 60 degree angle in a slow movement taking around 4 seconds to completely remove the tape. Both the sample and the tape were then assessed for coating removal and scored using the ISO 2409 standard, graded appropriately and compared against the OPV adhesion of a control can that was prepared without a primer layer.

Evaluation criteria for OPV adhesion:

A: Improvement or no change in adhesion compared to adhesion of inks on cleaned but non-primed cans

B: Noticeably worse adhesion compared to adhesion of inks on cleaned but non-primed cans

C: Significantly worse adhesion compared to adhesion of inks on cleaned but non-primed cans

The OPV adhesion is discussed in the evaluation of printed image quality above.

While the foregoing is directed to embodiments of the present invention, other and further embodiments of the invention will be apparent to those skilled in the art from consideration of the specification, and may be devised without departing from the basic scope thereof, which is determined by the claims that follow.

1-69. (canceled)

70. An apparatus for preparing a cylindrical object provided with a protective surface coating for decorating thereon using a printing technique, the apparatus comprising:
a priming station for applying a primer onto the protective surface coating of a cylindrical object; and
a drying station for drying said primer, once applied, to form a decoration surface over the protective surface coating for decorating the object thereon;
wherein the priming station and the drying station are arranged in series in the apparatus.

71. The apparatus of claim 70, wherein the priming station comprises an offset gravure arrangement including a gravure cylinder and a transfer roller.

72. The apparatus of claim 71, wherein the transfer roller is operable selectively to be brought into contact with the surface of the object, while maintaining contact with the gravure cylinder.

73. The apparatus of claim 72, wherein the priming station further comprises a drive mechanism arranged to engage with the object so as to drive axial rotation of the object while it is in contact with the transfer roller.

74. The apparatus of claim 73, wherein the drive mechanism is arranged to rotate the object at a speed independent of the speed of the transfer roller.

75. The apparatus of claim 70, wherein the drying station comprises at least one air outlet arranged to direct heated air onto the surface formed by the primer, preferably wherein the at least one air outlet is configured as an air blade.

76. The apparatus of claim 75, wherein the drying station further comprises a drive mechanism arranged to engage with the object so as to drive axial rotation of the object while it is being dried by heated air from the air outlet(s).

77. The apparatus of claim 70, further comprising a cleaning station for removing contaminants from the protective surface coating of the object before the primer is applied, wherein the cleaning station comprises a cleaning material that is compressible relative to the object against which the object may be rotated to clean the surface, preferably wherein the cleaning material is provided on a substantially planar substrate.

78. The apparatus of claim 70, further comprising at least one object holding device arranged to position said object at each station, wherein the holding device is arranged to move an object, sequentially, between said stations.

79. The apparatus of claim 78, wherein the holding device is arranged to retain the cylindrical object by engaging with opposed ends of said object, said holding device further being arranged to allow said object to be rotated about its longitudinal axis while retained.

80. The apparatus of claim 78, wherein the holding device is further arranged to allow air to be supplied to a hollow interior of an object retained by the holding device whereby to pressurise said object.

81. A method of preparing a cylindrical object provided with a protective surface coating for decorating thereon using a printing technique, the method comprising the steps of:
applying a primer composition onto the protective surface coating provided on the object; and
drying the primer, once applied, to form a decoration surface over the protective surface coating for decorating the object thereon;
wherein the steps of applying a primer composition and drying the primer composition are performed in series.

82. The method of claim 81, wherein applying the primer onto the coating is performed by an offset gravure process involving a gravure cylinder and a transfer roller.

83. The method of claim 81, further comprising pressurising the interior of the object while applying the primer, and optionally prior to applying the primer.

84. The method of claim 81, further comprising drying the primer by passing heated air over the surface of the object.

85. The method of claim 81, further comprising cleaning the coating to remove surface contaminants prior to applying the primer by wiping the object against a cleaning material, preferably wherein at least a portion of the cleaning material is wetted with a cleaning fluid.

86. The method of claim 85, wherein cleaning the coating comprises rotating the object against the cleaning material in a direction opposite to the direction of travel of the object so as to wipe the object, preferably wherein the object is maintained in a laterally stationary position relative to the cleaning material while in contact with the cleaning material.

87. The method of claim 85, further comprising drying the surface of the coating after the object has contacted the cleaning fluid, prior to applying the primer.

88. An object holding device for positioning the cylindrical object within the apparatus of claim 70, the device comprising:
a first engagement member arranged to engage with a first end of the object;
a second engagement member arranged to engage with a second end of the object; and
a retaining assembly arranged to maintain the first and second engagement members in a spaced-apart and moveably opposed configuration, the first and second engagement members being moveable relative to one another so as to receive and retain an object therebetween.

89. The device of claim 88, further comprising a fluid conduit in fluid communication with the first engagement member, wherein fluid may be introduced though the fluid conduit into a retained object via the first engagement member so as to pressurise the hollow interior of the object.
